(19) United States
(12) Patent Application Publication
(10) Pub. No.: US 2024/0411691 A1
(43) Pub. Date: Dec. 12, 2024

(54) COMPUTER MEMORY ACCESS FOR MACHINE LEARNING MODELS

(71) Applicant: Microsoft Technology Licensing, LLC, Redmond, WA (US)

(72) Inventors: Ori LASLO, Rehovot (IL); Gilad KIRSHENBOIM, Petach Tiqva (IL)

(73) Assignee: Microsoft Technology Licensing, LLC, Redmond, WA (US)

(21) Appl. No.: 18/332,683

(22) Filed: Jun. 9, 2023

(51) Int. Cl. G06F 12/08

(52) U.S. Cl. CPC G06F 12/08; G06F 17/16

(57) ABSTRACT

A method for computer memory access includes, during execution of a machine learning model, receiving an input vector for multiplication with a matrix of network weight values. Each network weight value of the matrix of network weight values is stored in computer memory using a stored quantity(S) of bits. For a network weight value of the matrix of network weight values, a representation quantity (R) of bits is determined to be used for representing the network weight value during multiplication with a corresponding vector value of the input vector, based at least in part on a magnitude of the corresponding vector value. The R bits of the network weight value are retrieved from the computer memory for multiplication with the corresponding vector value.

### BACKGROUND

Machine learning models often involve performing matrix operations, such as matrix multiplication, which require accessing network weight values stored in computer memory. The size and complexity of these models, coupled with the increasing demand for real-time inference, present challenges in terms of efficient memory access.

### BRIEF DESCRIPTION OF THE DRAWINGS

FIG. 1 schematically illustrates multiplication of an input vector against a matrix of network weight values retrieved from computer memory.

FIG. 2 illustrates an example method for computer memory access.

FIG. 3 schematically illustrates retrieval of network weight values from computer memory.

FIG. 4A schematically illustrates an example organizational system for storing network weight values in computer memory.

FIG. 4B schematically illustrates example compute logic for performing matrix vector multiplication using the organizational system of FIG. 4A.

FIG. 5 schematically illustrates another example organizational system for storing network weight values in computer memory.

FIG. 6 schematically shows an example computing system.

### DETAILED DESCRIPTION

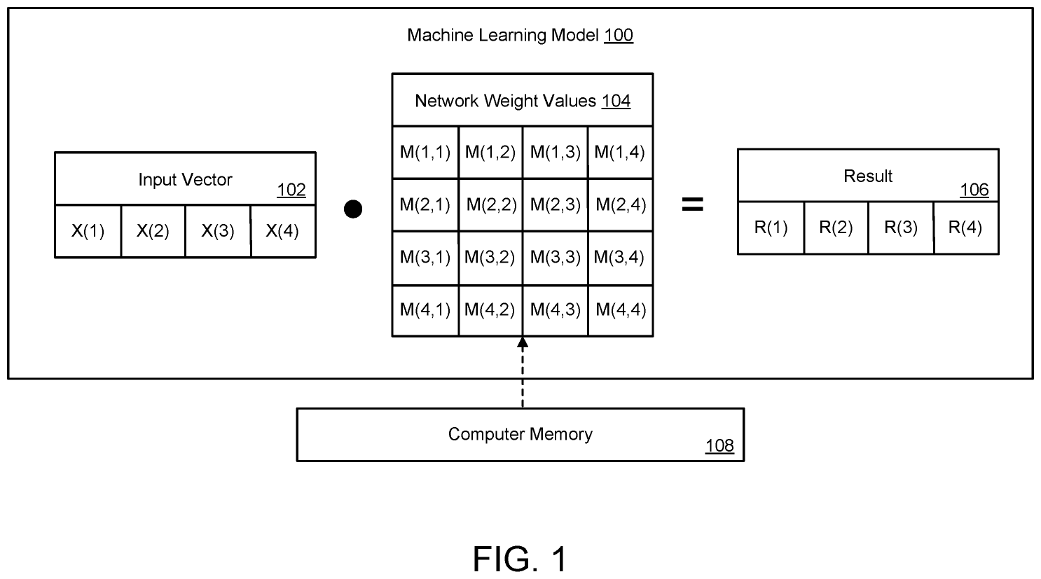

As discussed above, execution of a machine learning model often includes a number of steps in which an input vector is multiplied against a matrix of values retrieved from computer memory. This is schematically shown with respect to FIG. 1, illustrating execution of a machine learning model 100. As shown, execution of the model includes multiplication of an input vector 102 by a matrix of network weight values 104, to give a set of resulting values 106.

In the example of FIG. 1, the network weight values are retrieved from computer memory 108. Such retrieval is not instantaneous. Over a number of processing steps, in which different input vectors are multiplied against different matrices of network weight values, the aggregate time spent fetching weight values from computer memory can create a significant performance barrier. In other words, the overall speed of the machine learning model (e.g., expressed as inferences per second) is in some examples limited by the significant throughput used for reading network weight values from computer memory. For instance, conventional methods often retrieve and process the entire network weight value from memory, resulting in unnecessary data transfer and increased computational overhead.

This can be partially addressed by applying sparsity and/or quantization to the network values stored in memory—e.g., some to all of the network weight values may be truncated to a shorter number of bits, and/or reduced to zero, to reduce the amount of data for retrieval from memory. As examples, this may be done to quantize all the network weights to a predefined number of bits (e.g., eight bits), and/or based on each network weight's “importance” (e.g., indicated by the layer that each weight is included in, and/or each weight's actual value).

However, each of these approaches is applied ahead of time (e.g., prior to receiving an input vector as part of model execution), with no regard to the input vector that will be multiplied against the network weight values. This can significantly affect the accuracy of the machine learning model. For instance, instead of multiplying values of the input vector by the actual network weight values, they are instead multiplied by representations of the network weight values that have been shortened to a smaller number of bits, which can affect the result of the multiplication. This is referred to as “quantization error” and can, in some cases, affect the output of the machine learning model—e.g., causing the model's response to a user's input query to be less relevant and less satisfactory.

Accordingly, the present disclosure is directed to techniques for computer memory access, in which quantization is dynamically applied to network weight values based on corresponding values of the input vector. Notably, the techniques described herein may be applied on-the-fly during execution of the machine learning model, as compared to other approaches that are performed ahead of time. As such, the manner in which quantization is applied to any given network weight value can be adjusted based on the corresponding vector value that will be multiplied against the network weight value—e.g., based on the size of the vector value, and/or based on the relative difference between the vector value and other vector values of the input vector.

For instance, if the corresponding vector value is relatively high, then quantization applied to the network weight value can result in relatively more quantization error—e.g., even a small change in the network weight value can have a large effect on the resulting value when multiplied against a large vector value. As such, in one example approach, little to no quantization is applied to the network weight value when it is to be multiplied by a corresponding vector value that is a relatively large number (e.g., as compared to other values in the same vector). By contrast, if the corresponding vector value is relatively low, then more aggressive quantization can be applied to the network weight value—e.g., because the network weight value is multiplied by a relatively smaller number, any change in the network weight value caused by quantization is relatively less likely to have a significant effect on the resulting value.

In this manner, for each network weight value to be multiplied against an input vector, a computing system may determine a representation quantity (R) of bits that should be retrieved from computer memory as a representation of the network weight value. This may differ from a stored quantity(S) of bits used to store the network weight value in the computer memory. For instance, R may be relatively higher than the R values for other network weight values in cases where the corresponding vector value is relatively higher, and the corresponding vector values for the other network weight values are relatively lower, which serves to reduce quantization error as described above. However, in some cases R may be significantly less than S, or even reduced to zero, when quantization is relatively less likely to have a significant effect on the vector-matrix product—e.g., because the corresponding vector value is relatively low, or equal to zero.

This can significantly reduce the amount of data that is actually retrieved from computer memory, which provides a technical benefit of improving performance of the machine learning model. Specifically, by selectively retrieving a smaller number of bits for multiplication, the method minimizes data transfer and reduces computational overhead, thereby improving memory access efficiency. The reduced data transfer and computational overhead result in faster execution times for machine learning models, enabling real-time inference and improved overall system performance. This improved performance additionally consumes less electrical power (e.g., as less power is used to retrieve data from memory), which provides the technical benefit of reducing consumption of computational resources.

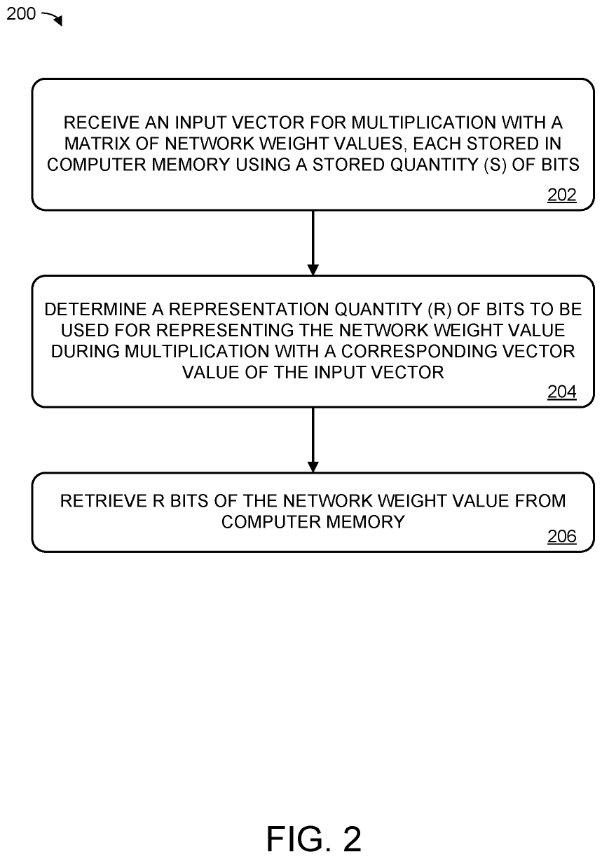

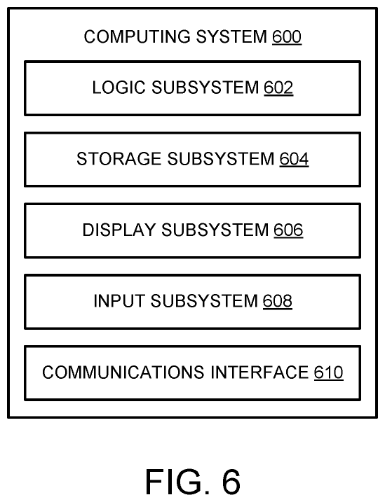

FIG. 2 illustrates an example method 200 for computer memory access. Method 200 may be performed by any suitable computing system of one or more computing devices. Any computing device performing steps of method 200 may have any suitable capabilities, hardware configuration, and form factor. Steps of method 200 may be initiated, terminated, or repeated at any suitable time, and in response to any suitable condition. In some examples, method 200 is implemented by computing system 600 described below with respect to FIG. 6.

Method 200 is primarily described as being performed during execution of a machine learning model. In one non-limiting example, the machine learning model is a transformer-based language model. However, it will be understood that the techniques described herein may be applied to any suitable type of machine learning model, in which input vectors are multiplied against matrices of values retrieved from computer memory. Non-limiting examples of additional machine learning (ML) and/or artificial intelligence (AI) techniques that may benefit from the techniques described herein will be provided below with respect to FIG. 6. Furthermore, it will be understood that the techniques for dynamic quantization described herein need not be specifically implemented only in scenarios involving execution of a machine learning model. Rather, the techniques described herein are applicable in a variety of scenarios where matrices of values are retrieved from computer memory for multiplication against input vectors, where retrieval of the data from memory creates a performance barrier.

At 202, method 200 includes receiving an input vector for multiplication with a matrix of network weight values. In the example of FIG. 1, an input vector 102 is received for multiplication with a matrix of network weight values 104, during execution of a machine learning model 100. As will be described in more detail below, each network value of the matrix of network weight values is stored in computer memory using the stored quantity S of bits. In some cases, S may be the same for each network weight value of the matrix. For instance, each network weight value may be stored using eight bits, or another suitable number. In other cases, S may differ for different network weight values—e.g., some values may be stored in memory using relatively more bits of data than other values.

In general, the input vector may take any suitable form and include any suitable number of vector values. Similarly, the actual vector values of the vector may have any suitable size and may encode or otherwise represent any suitable information. In various examples, the input vector is an input to a machine learning model, or an intermediary set of values produced during execution of the machine learning model, or is unrelated to execution of a machine learning model.

For instance, in one non-limiting example, the machine learning model is a transformer-based language model. Thus, for example, the input vector may represent tokens and/or words of a natural language input, encoded as the values X(1)-X(N) of an input vector X having N values. As another example, the input vector may represent attention values for one token of an input prompt, expressing the relevance or “connectedness” of other tokens in the same prompt. For instance, in the prompt “the boy runs to the store,” the words “boy” and “runs” are relatively more connected than the words “boy” and “store,” and this may be encoded by the values of the input vector. As another non-limiting example, input vectors may take the form of intermediate result vectors inside hidden layers of a transformer-based language model.

In some examples, the input vector is processed in one or more processing steps during execution of a machine learning model. For example, this may include iteratively processing the input vector through a plurality of encoder and decoder layers. In general, processing of an input vector often involves multiplication of the input vector by one or more matrices of values retrieved from computer memory, such as network weight values learned and refined during model training. As with the input vector, the matrix of values multiplied by the input vector may include any suitable number of values (e.g., arranged in any suitable number of discreet, rows, columns, and/or other groupings), each having any suitable size, and the matrix values may encode or otherwise represent any suitable information.

Similarly, the resulting values 108 after the input vector is multiplied by the matrix values may take any suitable form, and include any suitable number of different values. For example, in cases where a one-dimensional input vector is multiplied by a two-dimensional matrix, then the resulting values may similarly be expressed as a one-dimensional output vector. The resulting values are in some examples output as a result of the model (e.g., decoded as a response to the input prompt), output for continued processing by the model (e.g., used as a subsequent input vector for multiplication against a subsequent matrix of values in a next network layer), and/or used for any other suitable purpose.

Returning briefly to FIG. 2, at 204, method 200 includes, for a network weight value of the matrix of network weight values, determining a representation quantity R of bits to be used for representing the network weight value during multiplication with a corresponding vector value of the input vector. As discussed above, this is determined based at least in part on a magnitude of the corresponding vector value. For example, when multiplied by a relatively larger vector value, any quantization applied to a network weight value is relatively more likely to have a larger impact on the resulting value than would be the case if the network weight value was multiplied by a relatively smaller vector value.

To illustrate this, the following equation may be used to calculate the result vector resulting from multiplication between vector values X[i] of an input vector X, and the network weight values M[i,j] sorted into a column j of a matrix M:

$$Result [ j ] = {\sum }_{i = 1}^{N} X [ i ] \cdot M [ i , j ]$$

If values in M are quantized to some number of bits, a quantization error will be introduced that is inversely proportional to the number of bits used for the quantization. This will be represented using E[i,j].

$$Result [ j ] = {\sum }_{i = 1}^{N} X [ i ] \cdot ( M [ i , j ] + E [ i , j ] )$$

$$Result [ j ] = {\sum }_{i = 1}^{N} X [ i ] \cdot M [ i , j ] + {\sum }_{i = 1}^{N} X [ i ] \cdot E [ i , j ]$$

Therefore, the error in the resulting value caused by matrix quantization may be given by:

$$Error [ j ] = {\sum }_{i = 1}^{N} X [ i ] \cdot E [ i , j ]$$

As can be seen by the above relationships, larger values of X[i] will result in relatively larger quantization errors when multiplied against quantized network weight values. Thus, quantization error can be reduced by determining the value of R for a given network weight value based at least in part on the magnitude of the corresponding vector value (e.g., X[i]) to be multiplied against the network weight value. For instance, in some examples, R may be proportional to the magnitude of the corresponding vector value—e.g., in situations where the vector value is relatively large, quantization error may be reduced by setting R relatively high. In some cases, no quantization is performed, meaning R is equal to the number of bits S used to store the network weight value. When the value of the input vector is relatively smaller, R can be reduced to reduce the amount of data retrieved from computer memory. In a case where the corresponding vector value of the input vector is equal to zero, then R may be set to zero, and no bits of the network weight value need to be retrieved from memory. This provides the technical benefits of reducing consumption of computational resources (e.g., no electrical power is spent retrieving the zero bits from memory) and faster network performance (e.g., no time is spent retrieving the zero bits from memory).

The process for finding R is generally described as occurring for each network weight value. However, during vector multiplication with a matrix, each value of the vector is multiplied by every matrix value in a corresponding row of the matrix. Thus, it will be understood that determining R for a given network weight value in some cases refers to determining R for each network weight value in a same matrix row—e.g., all weight values in the same row are represented using the same quantity of bits, based at least in part on the magnitude of the vector value to be multiplied by the matrix row. In other examples, each network weight value stored in the same matrix column, or other suitable grouping, may have the same value of R.

The specific formula used for determining R may vary widely from one implementation to another, depending on various factors such as tolerance for quantization error, the desired speed of model execution (e.g., in terms of inferences per second), and/or power consumption considerations. In general, R may be calculated by a configurable formula that considers at least the value of the corresponding vector value (e.g., X[i]) as an input. The configurable formula may additionally consider any variety of other suitable information, as will be described below.

In some examples, the value of R is determined based at least in part on a difference between the corresponding vector value and other vector values of the input vector. For instance, if all vector values of the input vector are relatively homogeneous, then the R values for each network weight value multiplied by the input vector may be the same, or similar. However, if there is more diversity in the vector values of the input vector, then R values may be correspondingly adjusted. For instance, if one vector value is significantly lower than other vector values of the input vector, then any network weight values to be multiplied with the relatively lower vector value may have relatively lower values of R. Similarly, R may be relatively larger when the corresponding vector value is relatively higher than an average vector value of the input vector. This provides the technical benefits of improving network performance while preserving accuracy—e.g., relatively more bits are retrieved in cases where quantization is more likely to affect the calculation result, while time and power are conserved by reducing the number of bits retrieved for less impactful input vector values.

In some examples, R is further determined based at least in part on a power consumption policy of the computing device being used to execute the machine learning model. As discussed above, retrieving relatively more data from memory consumes relatively more electrical power. As such, in cases where it is desirable to reduce electrical power consumption (e.g., to preserve battery life of a portable device, or to reduce power consumed by a datacenter), then values of R may be set relatively lower. This can potentially increase quantization error, but improves the speed of the machine learning model, and reduces the power consumption associated with executing the machine learning model. For example, R may be determined based at least in part on a power consumption policy that is automatically applied contextually (e.g., when a portable device is using battery power), and/or user definable (e.g., the user may switch the device between different performance or power saving modes).

Additionally, or alternatively, a power consumption policy may be applied based on an identity of a human user interacting with the machine learning model. For example, a service that charges for access to a machine learning model may grant paid users access to a power consumption policy that prioritizes model performance and accuracy over power consumption. By contrast, free or trial users may be restricted to a power consumption policy that prioritizes energy efficiency over model accuracy.

Additionally, or alternatively, any other suitable criteria may be used in determining R for a given network weight value. As non-limiting examples, R may be determined based on any or all of: user-definable settings (e.g., a power consumption setting, an accuracy target setting), device hardware characteristics (e.g., mobile devices and/or devices with less powerful hardware may use less quantization by default), a current user identity (e.g., user is a free subscriber vs paid subscriber, user is an administrator with elevated privileges), and/or a device power state (e.g., plugged in vs running on battery).

The following are non-limiting examples of heuristics that may be considered when determining R for any given network weight value. For example, any or all of the following heuristics may be implemented as part of a heuristic-based function that determines R for a given network weight value, based on the corresponding vector value:
If all values of the input vector are relatively large (e.g., relative to other input vectors, relative to a user-defined threshold, relative to a threshold learned during model training, or relative to another suitable threshold), then in some cases, little to no quantization is applied to the network weight values. In other words, R is equal to S.
If all values of the input vector are relatively low or average relative to any suitable threshold, but relatively similar to one another (e.g., within one standard deviation), then relatively little quantization may be applied to all rows of the matrix M, as there is no single matrix row that is significantly more influential over the resulting value than other rows.
If all values of the input vector are relatively small, then the R value for each row of the matrix M may be relatively low, as any quantization error in M will likely only cause a small change in the resulting values.
If one or more values of the input vector are significantly larger than others, then R may be increased for the matrix row to be multiplied with the larger vector values and decreased for matrix rows to be multiplied with smaller matrix values.

In any case, for a given network weight value, the computing system determines a number of bits to be used for representing the network weight value during multiplication with the input vector. As such, returning briefly to FIG. 2, at 206, method 200 includes retrieving R bits of the network weight value for multiplication with the corresponding vector value.

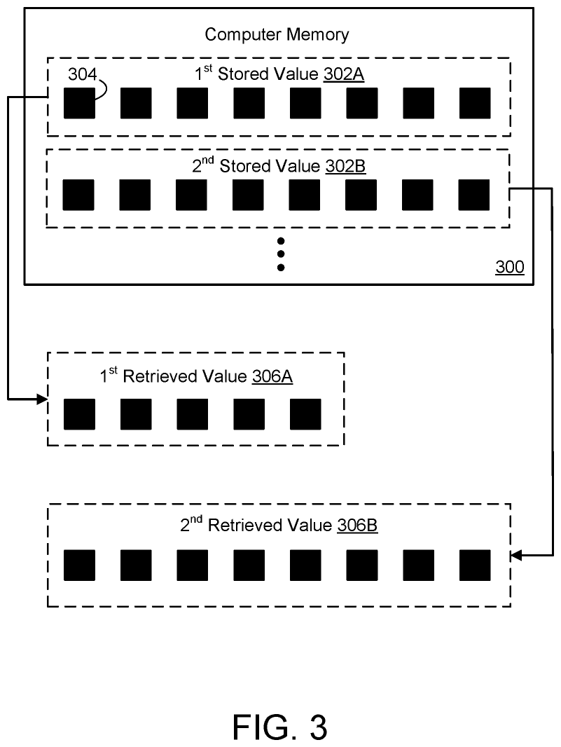

This is schematically illustrated with respect to FIG. 3, showing an example computer memory 300 storing a network weight value 302A. In this example, the network weight value is stored as eight bits, one of which is labeled as data bit 304. In other words, in FIG. 3, S is equal to eight. It will be understood that FIG. 3 is not intended to be an accurate representation of how data is stored or organized in computer memory, but rather is intended to be a simplified conceptual explanation of dynamic quantization. Furthermore, it will be understood that the techniques described herein are applicable to any suitable type of computer memory, including dynamic random access memory (DRAM), flash memory, static random access memory (SRAM), and/or other suitable memory types.

Based at least in part on a corresponding vector value to be multiplied with the stored network weight value 302A, the computing system determines that the network weight value should be quantized, and sets R to five. Thus, as shown, the computing system retrieves five bits as a retrieved value 306A, which represents the stored value 302A while using fewer bits than are stored in computer memory. In other words, in this example, R is a smaller number of bits than S, and thus at least some bits of the network weight value are stored in the computer memory and not retrieved for multiplication with the corresponding vector value. In such cases, where R is smaller than S, the S bits stored in memory may be shortened to R retrieved bits in any suitable way. This provides a technical benefit of reducing consumption of computational resources by reducing the amount of data retrieved from memory—e.g., reducing consumption of power and memory access throughput. As one example, the S bits may simply be truncated—e.g., the R most significant bits of the network weight value may be retrieved as stored, and any additional bits are not considered. In other examples, some degree of rounding may be used—e.g., bits 1 through R of the stored network value may be retrieved unmodified, while the value of bits (R+1) through S may be rounded up, rounded down, or filled with a middle value depending on the scenario.

As discussed above, different values of R may be used for each network weight value, and/or each matrix row (or column) of network weight values. As such, in some examples, the computing system determines a second representation quantity (R′) of bits to be used for representing a second network weight value during multiplication with a second corresponding vector value of the input vector. As with R, R′ may be determined based at least in part on a magnitude of the second corresponding vector value. For example, when the corresponding vector value used to determine R is smaller than the second corresponding vector value used to determine R′, then R may be a smaller number of bits than R′. As discussed above, in some examples, either or both of R and R′ may be equal to S, in which case all stored bits of the network weight value are retrieved for multiplication. This further provides a technical benefit as discussed above—e.g., by dynamically tuning the number of bits retrieved for different network weight values based on their corresponding input vector values, the computing system can reduce consumption of resources and improve performance of the model while still preserving accuracy.

This is also schematically illustrated with respect to FIG. 3, in which computer memory 300 additionally stores a second network weight value 302B. As shown, second network weight value 302B is also stored using eight bits (e.g., S is equal to eight). The computing system determines R′ bits of the second stored network weight value for retrieval as a retrieved value 306B, representing the second network weight value. In this example, R′ is equal to S, and thus every bit used to store the second network weight value in computer memory is retrieved for multiplication with the second corresponding vector value.

Typically, the network weight values in a particular column of the matrix will be stored inside a same memory row or memory page in computer memory. By contrast, in some embodiments described herein, the values of the matrix are read from computer memory row-by-row, such that network weight values in a same row of the matrix are stored in a same memory row of the computer memory. This beneficially improves the ability of the computing system to retrieve data from computer memory as described herein, resulting in an improvement to the performance of the machine learning model. The present disclosure primarily describes network matrix values as being stored in memory “rows,” although it will be understood that the techniques described herein may additionally or alternatively be used to read network weight values from memory pages—e.g., rather than reading memory row-by-row, the memory may be read page-by-page.

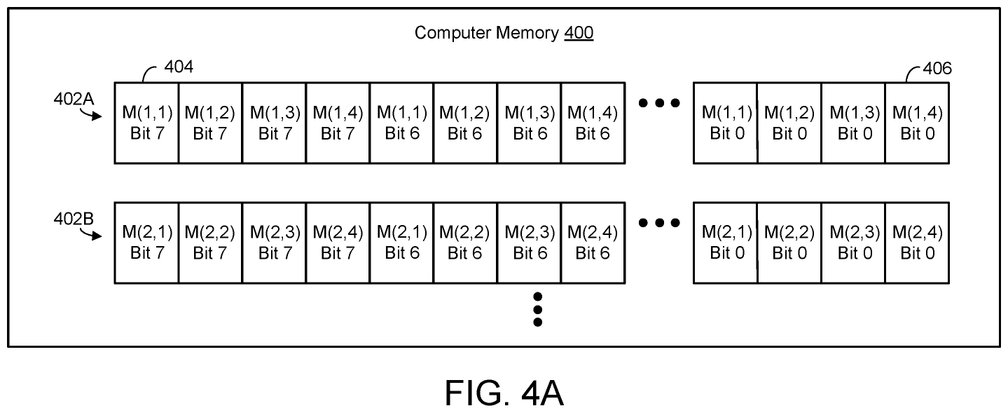

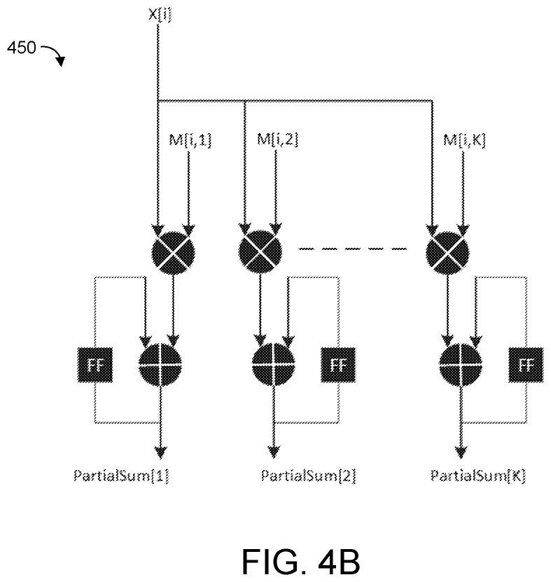

Specifically, FIG. 4A schematically illustrates one non-limiting example system for organizing data bits in computer memory. As with FIG. 3, it will be understood that FIG. 4A is highly simplified and intended only to serve as a conceptual representation of how data may be organized in computer memory. FIG. 4A shows another example computer memory 400, storing two rows of data 400A and 400B. The bits stored in computer memory 400 are based on the matrix of network weight values 104 shown in FIG. 1. As shown in FIG. 4A, the matrix of network weight values are stored such that the values in a same row in the matrix are stored in a same memory row of the computer memory—e.g., the first row of matrix 104 includes values M(1,1)-M(1,4), which are each included in memory row 402A.

Furthermore, in this example, the memory rows are organized beginning with the most significant bits for each network weight value, and ending with the least significant bits for each network weight value. Specifically, in FIG. 4A, the stored network weight values are quantized using int8 quantization, and thus are each stored using eight bits. The memory row begins with bit 7 for each network weight value in the same matrix row, corresponding to the most significant bit for each network weight value. For example, row 402A begins with bit 404, which is the most significant bit for matrix value M(1,1), followed by the most significant bits for matrix values M(1,2)-M(1,4). The memory row then continues with bit 6 for each network weight value, followed by bit 5, and so on, until reaching bit 0—the least significant bit for each network weight value. As shown, memory row 402A ends with bit 406, which is the least significant bit for matrix value M(1,4).

This provides a technical benefit by improving the speed and efficiency of memory access. In particular, the R bits used to represent each network weight value in the same matrix row are the first bits in the computer memory row. The computing system may then read out the data bits by reading the memory row until R bits for each network weight value have been retrieved, and then the computing system may move on to network weight values of the next matrix row, stored in the next memory row. This improves the speed of memory access, as unneeded values are not read from each row. For example, row 402B includes network weight values M(2,1)-M(2,4), each held in the same row of matrix 104. This beneficially enables the computing system to implement the techniques described herein while still using incremental addressing.

It will be understood that a similar system may be applied regardless of the number of bits used to store each network weight value. For example, when int16 quantization is used, each memory row may still begin with the most significant bits for the network weight values in the same matrix row (e.g., bit 15), and end with the least significant bits (e.g., bit 0).

It will be understood that the specific scenario shown in FIG. 4A includes four different network weight values for each row in the matrix. In other words, the matrix includes K columns, and K=4 in the examples described herein. This may, for instance, correspond to a SIMD (single instruction, multiple data) width of 4. However, it will be understood that this is non-limiting, and a matrix of network weight values may have any suitable number of columns.

Similarly, in FIG. 4A, the computer memory only includes two memory rows, corresponding to the first two rows of matrix 104. It will be understood that this is only done for the sake of visual clarity. In general, the computer memory may include different memory rows for each matrix row of the matrix of network weight values, and may include any number of additional memory rows for storing any other suitable data. Furthermore, the approach shown in FIG. 4A may be used regardless of whether the bits are expressed using standard int8 (where bit 7 is the sign bit), and for unsigned int8 (where bit 7 represents the multiplication factor for 2\hat{ }7). Additionally, it will be understood that, in some cases, multiple matrix rows of network weight values may be stored in the same memory row—e.g., if the matrix row size is smaller than the memory row size.

FIG. 4B shows an example diagram 450 for compute logic usable to perform the matrix-vector multiplication, when bits are stored in memory as shown in FIG. 4A. In this case, the number of multipliers changes from N (the number of values in the input vector row), to K (the number of columns in the matrix of values), where N and K will be the same in some examples. Similarly, instead of a single large N-input adder, the compute logic uses K small 2-input adders. In cases where it is desirable to optimize power over silicon area, then the compute section may optionally include different multipliers for different quantization values (e.g., 4 bits vs 8 bits). This can enable the computing system to select an appropriate multiplier depending on the quantization determined for each row of the matrix, which can conserve electrical power in the compute section when relatively more quantization is applied for a specific row.

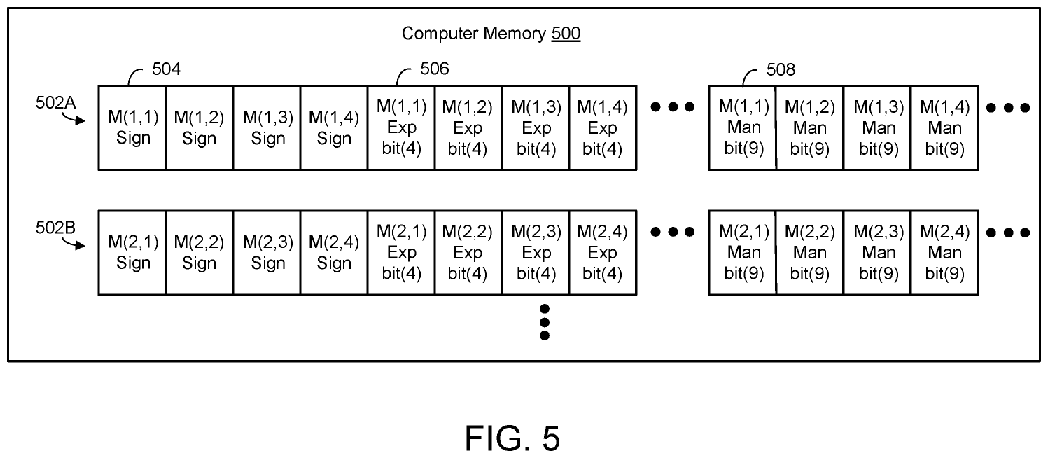

In some examples, the bits for the network weight values are stored in computer memory using a floating-point representation (e.g., FP32, FP16, FP8 . . . ). FIG. 5 schematically illustrates another example system for organizing bits in computer memory, in which FP16 is used. As with FIGS. 3 and 4A, it will be understood that FIG. 5 is highly simplified and intended only as a conceptual representation of how data may be organized in computer memory.

Specifically, FIG. 5 schematically shows an example computer memory 500, which again includes two memory rows 502A and 502B corresponding to network weight values held in the first two rows of matrix 104. In this example, the memory rows are organized such that each memory row begins with sign bits for each network value stored in the memory row, followed by exponent bits for each network value stored in the memory row, and ending with mantissa bits for each network value stored in the memory row. This beneficially improves the speed and efficiency of memory access by again reducing the amount of unnecessary data that is read from each row, depending on the R value determined for that row. For example, row 502A begins with bit 504, which is a sign bit for network weight value M(1,1), and is followed by sign bits for values M(1,2)-M(1,4). Next, the memory row includes a bit 506, which is a first exponent bit for value M(1,1). This is followed by additional exponent bits for each network weight value (e.g., exponent bits 4, 3, 2, 1, and 0 for each network weight value). After the exponent bits, the memory row includes a bit 508, which is a first mantissa bit for value M(1,1). This is followed by additional mantissa bits for each network weight value (e.g., mantissa bits 9-0 for each network weight value).

Notably, in the example of FIG. 5, then the computing system only reads every exponent bit for a given network weight value if any mantissa bits for that matrix row of network weight values must be retrieved. In cases where the computing system need not read any mantissa bits (e.g., only sign and exponent bits are read, or the entire row is pruned and represented by zero), then the computing system is beneficially able to read less than all exponent bits for a given network weight value. This provides the technical benefit of improving the speed of model execution.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 6 schematically shows a simplified representation of a computing system 600 configured to provide any to all of the compute functionality described herein. Computing system 600 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 600 includes a logic subsystem 602 and a storage subsystem 604. Computing system 600 may optionally include a display subsystem 606, input subsystem 608, communication subsystem 610, and/or other subsystems not shown in FIG. 6.

Logic subsystem 602 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 604 includes one or more physical devices configured to temporarily and/or permanently hold computer information such as data and instructions executable by the logic subsystem. When the storage subsystem includes two or more devices, the devices may be collocated and/or remotely located. Storage subsystem 604 may include volatile, nonvolatile, dynamic, static, read/write, read-only, random-access, sequential-access, location-addressable, file-addressable, and/or content-addressable devices. Storage subsystem 604 may include removable and/or built-in devices. When the logic subsystem executes instructions, the state of storage subsystem 604 may be transformed—e.g., to hold different data.

Aspects of logic subsystem 602 and storage subsystem 604 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

Language models may utilize vocabulary features to guide sampling/searching for words for recognition of speech. For example, a language model may be at least partially defined by a statistical distribution of words or other vocabulary features. For example, a language model may be defined by a statistical distribution of n-grams, defining transition probabilities between candidate words according to vocabulary statistics. The language model may be further based on any other appropriate statistical features, and/or results of processing the statistical features with one or more machine learning and/or statistical algorithms (e.g., confidence values resulting from such processing). In some examples, a statistical model may constrain what words may be recognized for an audio signal, e.g., based on an assumption that words in the audio signal come from a particular vocabulary.

Alternately or additionally, the language model may be based on one or more neural networks previously trained to represent audio inputs and words in a shared latent space, e.g., a vector space learned by one or more audio and/or word models (e.g., wav2letter and/or word2vec). Accordingly, finding a candidate word may include searching the shared latent space based on a vector encoded by the audio model for an audio input, in order to find a candidate word vector for decoding with the word model. The shared latent space may be utilized to assess, for one or more candidate words, a confidence that the candidate word is featured in the speech audio.

The language model may be used in conjunction with an acoustical model configured to assess, for a candidate word and an audio signal, a confidence that the candidate word is included in speech audio in the audio signal based on acoustical features of the word (e.g., mel-frequency cepstral coefficients, formants, etc.). Optionally, in some examples, the language model may incorporate the acoustical model (e.g., assessment and/or training of the language model may be based on the acoustical model). The acoustical model defines a mapping between acoustic signals and basic sound units such as phonemes, e.g., based on labelled speech audio. The acoustical model may be based on any suitable combination of state-of-the-art or future machine learning (ML) and/or artificial intelligence (AI) models, for example: deep neural networks (e.g., long short-term memory, temporal convolutional neural network, restricted Boltzmann machine, deep belief network), hidden Markov models (HMM), conditional random fields (CRF) and/or Markov random fields, Gaussian mixture models, and/or other graphical models (e.g., deep Bayesian network). Audio signals to be processed with the acoustic model may be pre-processed in any suitable manner, e.g., encoding at any suitable sampling rate, Fourier transform, band-pass filters, etc. The acoustical model may be trained to recognize the mapping between acoustic signals and sound units based on training with labelled audio data. For example, the acoustical model may be trained based on labelled audio data comprising speech audio and corrected text, in order to learn the mapping between the speech audio signals and sound units denoted by the corrected text. Accordingly, the acoustical model may be continually improved to improve its utility for correctly recognizing speech audio.

In some examples, in addition to statistical models, neural networks, and/or acoustical models, the language model may incorporate any suitable graphical model, e.g., a hidden Markov model (HMM) or a conditional random field (CRF). The graphical model may utilize statistical features (e.g., transition probabilities) and/or confidence values to determine a probability of recognizing a word, given the speech audio and/or other words recognized so far. Accordingly, the graphical model may utilize the statistical features, previously trained machine learning models, and/or acoustical models to define transition probabilities between states represented in the graphical model.

When included, display subsystem 606 may be used to present a visual representation of data held by storage subsystem 604. This visual representation may take the form of a graphical user interface (GUI). Display subsystem 606 may include one or more display devices utilizing virtually any type of technology. In some implementations, display subsystem may include one or more virtual-, augmented-, or mixed reality displays.

When included, input subsystem 608 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 610 may be configured to communicatively couple computing system 600 with one or more other computing devices. Communication subsystem 610 may include wired and/or wireless communication devices compatible with one or more different communication protocols. The communication subsystem may be configured for communication via personal-, local- and/or wide-area networks.

The methods and processes disclosed herein may be configured to give users and/or any other humans control over any private and/or potentially sensitive data. Whenever data is stored, accessed, and/or processed, the data may be handled in accordance with privacy and/or security standards. When user data is collected, users or other stakeholders may designate how the data is to be used and/or stored. Whenever user data is collected for any purpose, the user data may only be collected with the utmost respect for user privacy (e.g., user data may be collected only when the user owning the data provides affirmative consent, and/or the user owning the data may be notified whenever the user data is collected). If the data is to be released for access by anyone other than the user or used for any decision-making process, the user's consent may be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible, anonymized, to further protect user privacy. Users may designate portions of data, metadata, or statistics/results of processing data for release to other parties, e.g., for further processing. Data that is private and/or confidential may be kept completely private, e.g., only decrypted temporarily for processing, or only decrypted for processing on a user device and otherwise stored in encrypted form. Users may hold and control encryption keys for the encrypted data. Alternately or additionally, users may designate a trusted third party to hold and control encryption keys for the encrypted data, e.g., so as to provide access to the data to the user according to a suitable authentication protocol.

When the methods and processes described herein incorporate ML and/or AI components, the ML and/or AI components may make decisions based at least partially on training of the components with regard to training data. Accordingly, the ML and/or AI components may be trained on diverse, representative datasets that include sufficient relevant data for diverse users and/or populations of users. In particular, training data sets may be inclusive with regard to different human individuals and groups, so that as ML and/or AI components are trained, their performance is improved with regard to the user experience of the users and/or populations of users.

ML and/or AI components may additionally be trained to make decisions so as to minimize potential bias towards human individuals and/or groups. For example, when AI systems are used to assess any qualitative and/or quantitative information about human individuals or groups, they may be trained so as to be invariant to differences between the individuals or groups that are not intended to be measured by the qualitative and/or quantitative assessment, e.g., so that any decisions are not influenced in an unintended fashion by differences among individuals and groups.

ML and/or AI components may be designed to provide context as to how they operate, so that implementers of ML and/or AI systems can be accountable for decisions/assessments made by the systems. For example, ML and/or AI systems may be configured for replicable behavior, e.g., when they make pseudo-random decisions, random seeds may be used and recorded to enable replicating the decisions later. As another example, data used for training and/or testing ML and/or AI systems may be curated and maintained to facilitate future investigation of the behavior of the ML and/or AI systems with regard to the data. Furthermore, ML and/or AI systems may be continually monitored to identify potential bias, errors, and/or unintended outcomes.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for computer memory access comprises: during execution of a machine learning model, receiving an input vector for multiplication with a matrix of network weight values, wherein each network weight value of the matrix of network weight values is stored in computer memory using a stored quantity(S) of bits; for a network weight value of the matrix of network weight values, determining a representation quantity (R) of bits to be used for representing the network weight value during multiplication with a corresponding vector value of the input vector, based at least in part on a magnitude of the corresponding vector value; and retrieving R bits of the network weight value from the computer memory for multiplication with the corresponding vector value. In this example or any other example, R is a smaller number of bits than S, such that at least some bits of the network weight value are stored in the computer memory and not retrieved for multiplication with the corresponding vector value. In this example or any other example, the method further comprises, for a second network weight value of the matrix of network weight values, determining a second representation quantity (R′) of bits to be used for representing the second network weight value during multiplication with a second corresponding vector value of the input vector, based at least in part on a magnitude of the second corresponding vector value. In this example or any other example, the corresponding vector value is smaller than the second corresponding vector value, and wherein R is a smaller number of bits than R′. In this example or any other example, R′ is equal to S, such that all stored bits of the second network weight value are retrieved for multiplication with the second corresponding vector value. In this example or any other example, the corresponding vector value of the input vector is equal to zero, and R is equal to zero. In this example or any other example, R is further determined based at least in part on a difference between the corresponding vector value and other vector values of the input vector. In this example or any other example, R is relatively larger based at least in part on determining that the corresponding vector value is relatively higher than an average vector value of the input vector. In this example or any other example, R is further determined based at least in part on a power consumption policy of the computing device. In this example or any other example, the matrix of network weight values are stored in the computer memory such that network weight values in a same row of the matrix are stored in a same memory row or memory page of the computer memory. In this example or any other example, the same memory row or memory page is organized beginning with most significant bits for each network weight value, and ending with least significant bits for each network weight value. In this example or any other example, the same memory row or memory page is organized beginning with sign bits, followed by exponent bits, and ending with mantissa bits for each network value stored in the same memory row or memory page. In this example or any other example, the machine learning model is a transformer-based language model. In this example or any other example, the input vector represents tokens of a natural language input. In this example or any other example, the input vector represents intermediate result vectors inside hidden layers of the transformer-based language model. In this example or any other example, the computer memory includes one or more of dynamic random-access memory (DRAM), flash memory, and static random-access memory (SRAM).

In an example, a computing system comprises: a logic subsystem; and a storage subsystem including computer memory, the storage subsystem holding instructions executable by the logic subsystem to: during execution of a machine learning model, receive an input vector for multiplication with a matrix of network weight values, wherein each network weight value of the matrix of network weight values is stored in the computer memory using a stored quantity(S) of bits; for a network weight value of the matrix of network weight values, determine a representation quantity (R) of bits to be used for representing the network weight value during multiplication with a corresponding vector value of the input vector, based at least in part on a magnitude of the corresponding vector value; and retrieve R bits of the network weight value from the computer memory for multiplication with the input vector. In this example or any other example, R is a smaller number of bits than S, such that at least some bits of the network weight value are stored in the computer memory and not retrieved for multiplication with the corresponding vector value. In this example or any other example, the instructions are further executable to, for a second network weight value of the matrix of network weight values, determine a second representation quantity (R′) of bits to be used for representing the second network weight value during multiplication with a second corresponding vector value of the input vector, based at least in part on a magnitude of the second corresponding vector value, wherein the corresponding vector value is smaller than the second corresponding vector value, and wherein R is a smaller number of bits than R′.

In an example, a method for computer memory access comprises: during execution of a machine learning model, receiving an input vector for multiplication with a matrix of network weight values, wherein each network weight value of the matrix of network weight values is stored in computer memory using a stored quantity(S) of bits; for a network weight value of the matrix of network weight values, determining a representation quantity (R) of bits to be used for representing the network weight value during multiplication with a first corresponding vector value of the input vector, based at least in part on a magnitude of the first corresponding vector value, wherein R is a smaller number of bits than S; retrieving R bits of the network weight value from the computer memory for multiplication with the first corresponding vector value, such that at least some bits of the network weight value are stored in the computer memory and not retrieved for multiplication with the first corresponding vector value; and retrieving S bits of a second network weight value from the computer memory for multiplication with a second corresponding vector value of the input vector, the second corresponding vector value being larger than the first corresponding vector value.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for computer memory access, comprising:
during execution of a machine learning model, receiving an input vector for multiplication with a matrix of network weight values, wherein each network weight value of the matrix of network weight values is stored in computer memory using a stored quantity(S) of bits;
for a network weight value of the matrix of network weight values, determining a representation quantity (R) of bits to be used for representing the network weight value during multiplication with a corresponding vector value of the input vector, based at least in part on a magnitude of the corresponding vector value; and
retrieving R bits of the network weight value from the computer memory for multiplication with the corresponding vector value.

2. The method of claim 1, wherein R is a smaller number of bits than S, such that at least some bits of the network weight value are stored in the computer memory and not retrieved for multiplication with the corresponding vector value.

3. The method of claim 1, further comprising, for a second network weight value of the matrix of network weight values, determining a second representation quantity (R′) of bits to be used for representing the second network weight value during multiplication with a second corresponding vector value of the input vector, based at least in part on a magnitude of the second corresponding vector value.

4. The method of claim 3, wherein the corresponding vector value is smaller than the second corresponding vector value, and wherein R is a smaller number of bits than R′.

5. The method of claim 4, wherein R′ is equal to S, such that all stored bits of the second network weight value are retrieved for multiplication with the second corresponding vector value.

6. The method of claim 1, wherein the corresponding vector value of the input vector is equal to zero, and R is equal to zero.

7. The method of claim 1, wherein R is further determined based at least in part on a difference between the corresponding vector value and other vector values of the input vector.

8. The method of claim 7, wherein R is relatively larger based at least in part on determining that the corresponding vector value is relatively higher than an average vector value of the input vector.

9. The method of claim 1, wherein R is further determined based at least in part on a power consumption policy of the computing device.

10. The method of claim 1, wherein the matrix of network weight values are stored in the computer memory such that network weight values in a same row of the matrix are stored in a same memory row or memory page of the computer memory.

11. The method of claim 10, wherein the same memory row or memory page is organized beginning with most significant bits for each network weight value, and ending with least significant bits for each network weight value.

12. The method of claim 10, wherein the same memory row or memory page is organized beginning with sign bits, followed by exponent bits, and ending with mantissa bits for each network value stored in the same memory row or memory page.

13. The method of claim 1, wherein the machine learning model is a transformer-based language model.

14. The method of claim 13, wherein the input vector represents tokens of a natural language input.

15. The method of claim 13, wherein the input vector represents intermediate result vectors inside hidden layers of the transformer-based language model.

16. The method of claim 1, wherein the computer memory includes one or more of dynamic random-access memory (DRAM), flash memory, and static random-access memory (SRAM).

17. A computing system, comprising:
a logic subsystem; and
a storage subsystem including computer memory, the storage subsystem holding instructions executable by the logic subsystem to:
during execution of a machine learning model, receive an input vector for multiplication with a matrix of network weight values, wherein each network weight value of the matrix of network weight values is stored in the computer memory using a stored quantity(S) of bits;
for a network weight value of the matrix of network weight values, determine a representation quantity (R) of bits to be used for representing the network weight value during multiplication with a corresponding vector value of the input vector, based at least in part on a magnitude of the corresponding vector value; and
retrieve R bits of the network weight value from the computer memory for multiplication with the input vector.

18. The computing system of claim 17, wherein R is a smaller number of bits than S, such that at least some bits of the network weight value are stored in the computer memory and not retrieved for multiplication with the corresponding vector value.

19. The computing system of claim 17, wherein the instructions are further executable to, for a second network weight value of the matrix of network weight values, determine a second representation quantity (R′) of bits to be used for representing the second network weight value during multiplication with a second corresponding vector value of the input vector, based at least in part on a magnitude of the second corresponding vector value, wherein the corresponding vector value is smaller than the second corresponding vector value, and wherein R is a smaller number of bits than R′.

20. A method for computer memory access, comprising:
during execution of a machine learning model, receiving an input vector for multiplication with a matrix of network weight values, wherein each network weight value of the matrix of network weight values is stored in computer memory using a stored quantity(S) of bits;
for a network weight value of the matrix of network weight values, determining a representation quantity (R) of bits to be used for representing the network weight value during multiplication with a first corresponding vector value of the input vector, based at least in part on a magnitude of the first corresponding vector value, wherein R is a smaller number of bits than S;
retrieving R bits of the network weight value from the computer memory for multiplication with the first corresponding vector value, such that at least some bits of the network weight value are stored in the computer memory and not retrieved for multiplication with the first corresponding vector value; and
retrieving S bits of a second network weight value from the computer memory for multiplication with a second corresponding vector value of the input vector, the second corresponding vector value being larger than the first corresponding vector value.
